(19) United States
(12) Patent Application Publication
(10) Pub. No.: US 2018/0201057 A1
(43) Pub. Date: Jul. 19, 2018

(54) AUTOMOBILE HUB PROTECTIVE COVER

(71) Applicant: YUAN CHENG AUTO ACCESSORIES MANUFACTURER CO., LTD., TAIZHOU (CN)

(72) Inventor: MENGFEI XU, TAIZHOU (CN)

(73) Assignee: YUAN CHENG AUTO ACCESSORIES MANUFACTURER CO., LTD., TAIZHOU (CN)

(21) Appl. No.: 15/866,467

(22) Filed: Jan. 10, 2018

(30) Foreign Application Priority Data
Jan. 19, 2017 (CN) 201710044300.3

(51) Int. Cl. B60B 7/02; B60B 7/06; B60B 7/08

(52) U.S. Cl. CPC B60B 7/02; B60S 3/042; B60B 7/08; B60B 7/066

(57) ABSTRACT

An automobile hub protective cover comprises a support ring and a shielding body. The support ring is made of a metal wire or strip, the shielding body is made of cloth or soft plastic sheet or leather. The support ring is wrapped by the shielding body after being folded, and the support ring and the shielding body are integrally connected by means of a sewing thread or welding, or a connecting body is provided, the connecting body being made of cloth or leather or soft plastic, and the connecting body integrally connecting the support ring and the shielding body by means of a sewing thread or welding.

### TECHNICAL FIELD

The present invention relates to the technical field of automobile hub protection, and in particular to a hub protective cover for preventing chemicals such as a detergent and a brightener from being sprayed onto the surface of a metal hub during tire maintenance.

### BACKGROUND ART

Tires 10 of an automobile are in direct contact with the ground, and are very prone to damage, resulting in an oxidized and matte surface of the tire, and the occurrence of cracks, bulging and so on in the surface, which seriously affect the driving safety. Therefore, the tires need frequent maintenance, such as spraying of detergent, brightener, tire wax, etc. onto the surface of the tires. The tire detergent, brightener and tire wax are all chemicals, and if they are sprayed onto a metal hub 11 but then not be cleaned off, the metal hub 11 is easily prone to cracks and small holes, which affect the service life of the hub and the driving safety.

### SUMMARY OF THE INVENTION

An object of the present invention is to provide a hub protective cover which, when a tire is sprayed with a detergent and a brightener and is waxed, shields a metal hub to prevent chemicals from coming into direct contact with the metal hub, and which can be folded, thereby reducing the packaging size and the transportation cost, and being convenient to carry.

The object of the present invention is achieved as follows:

An automobile hub protective cover, comprising a support ring and a shielding body, characterized in that the support ring is made of a metal wire or strip, and the shielding body is made of cloth or soft plastic sheet or leather; and

The support ring is wrapped by the shielding body after being folded, and the support ring and the shielding body are integrally connected by means of a sewing thread or welding,

Or a connecting body is provided, the connecting body being made of cloth or leather or soft plastic, and the connecting body integrally connecting the support ring and the shielding body by means of a sewing thread or welding.

The diameter or thickness of the metal wire or strip used for the support ring is not greater than 5 mm and the width of the strip is not greater than 30 mm.

Two ends of the metal wire or strip used for the support ring are connected to each other by means of welding, riveting or cold pressing, so as to form a circular ring, the diameter of which should be able to completely cover a corresponding automobile hub.

When the shielding body is made of cloth, a surface of the shielding body is provided with at least a coating layer for preventing permeation of liquid.

A handle is arranged on the shielding body.

The handle is made of cloth or soft plastic sheet or leather.

The handle is connected to the shielding body by means of a sewing thread or welding.

Two or more inserts are arranged spaced apart on the support ring.

The inserts are detachably connected to the support ring in a reversely-fastening manner; or the inserts are undetectably fixed to the support ring by means of welding or riveting.

The insert is provided at a front end with a projection engageable with a hub.

### BRIEF DESCRIPTION OF THE DRAWINGS

FIG. 1 is a schematic perspective view of the present invention.

FIG. 2 is a front view of the present invention.

FIG. 3 is a sectional view of a first structure of the present invention, with a reversely-fastening opening of an insert facing downward.

FIG. 4 is a sectional view of a second structure of the present invention, with a support ring being wrapped by a shielding body after being folded.

FIG. 5 is a partial sectional view of the present invention, with the reversely-fastening opening of the insert facing forward.

FIG. 6 is a partial sectional view of the present invention with the insert being sheathed on the support ring.

FIG. 7 is a partial sectional view of the present invention, with the reversely-fastening opening of the insert facing forward and the opening 52 being chamfered.

FIG. 8 is an enlarged view of part A in FIG. 1.

FIG. 9 is a schematic perspective view of the present invention when not mounted to a hub of an automobile 20.

FIG. 10 is a schematic perspective view of the present invention when mounted to the hub 11 of the automobile 20.

FIG. 11 is a schematic perspective view of the present invention when bent and folded from an unfolded state to a folded state.

### DETAILED DESCRIPTION OF EMBODIMENTS

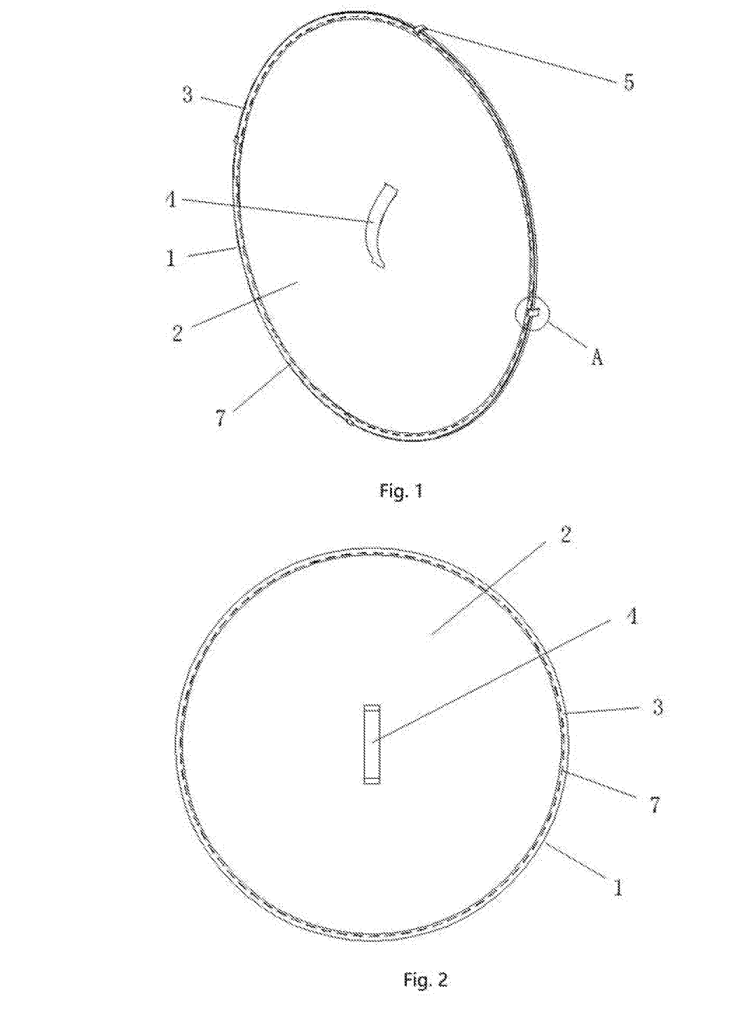

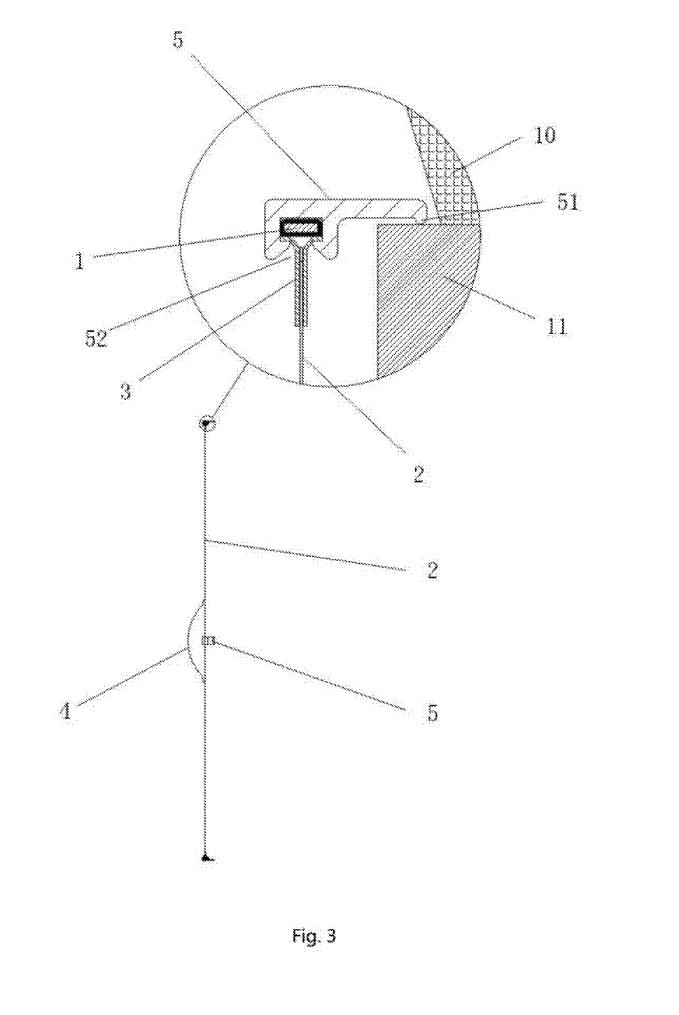

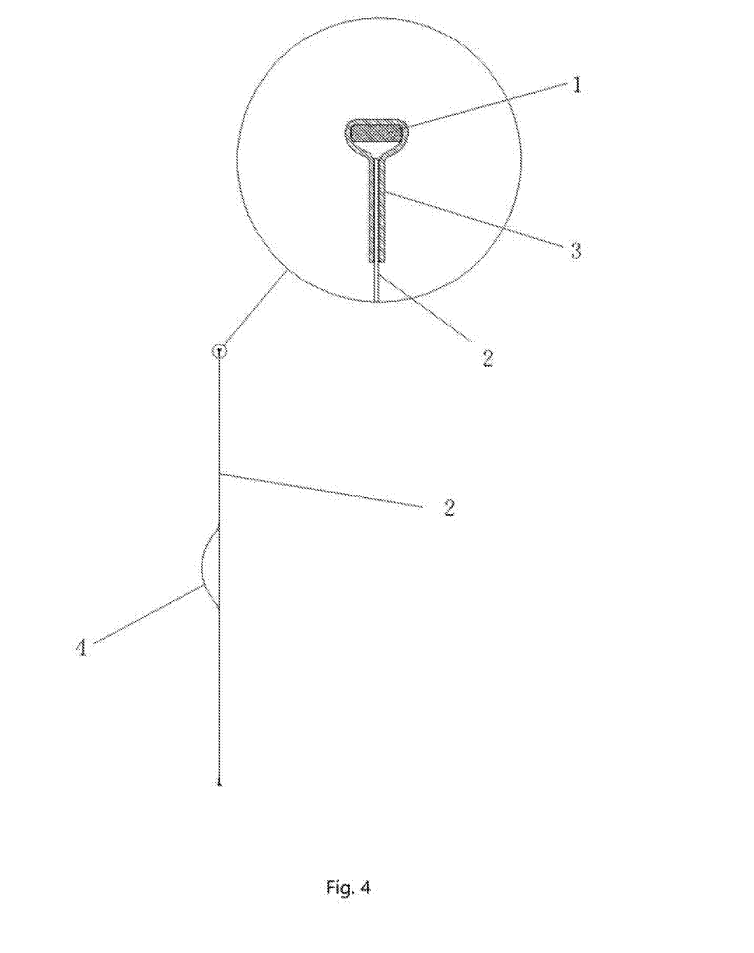

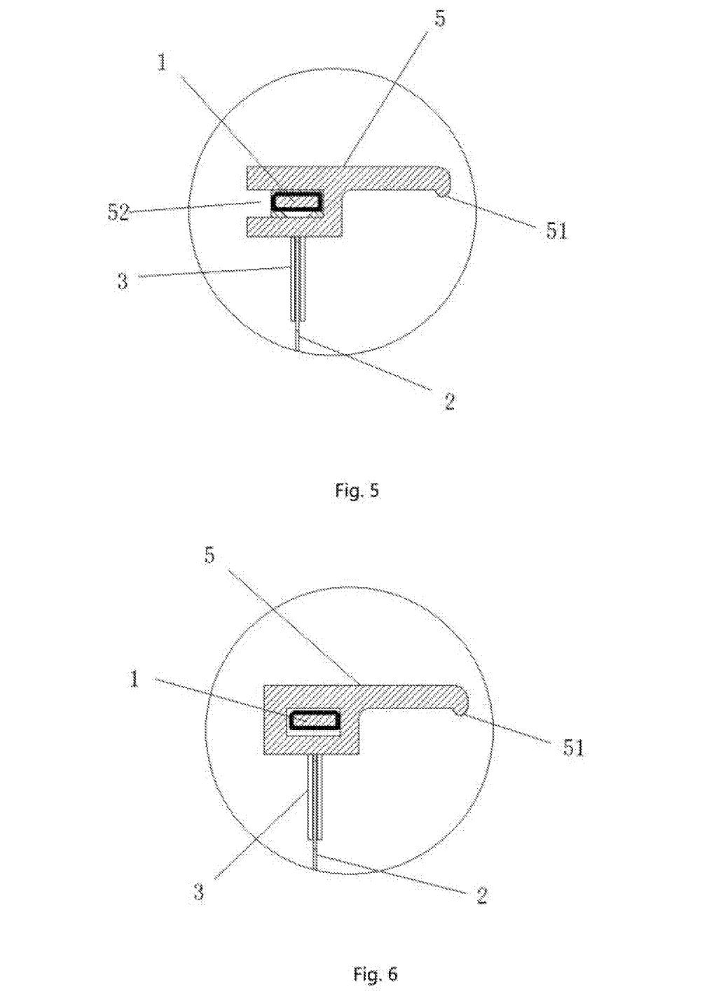

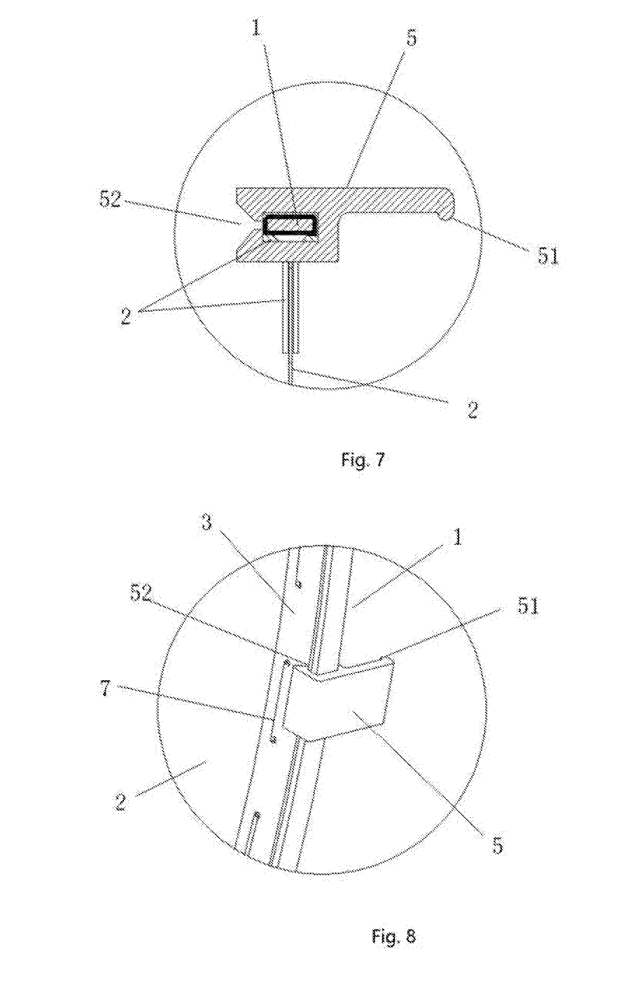

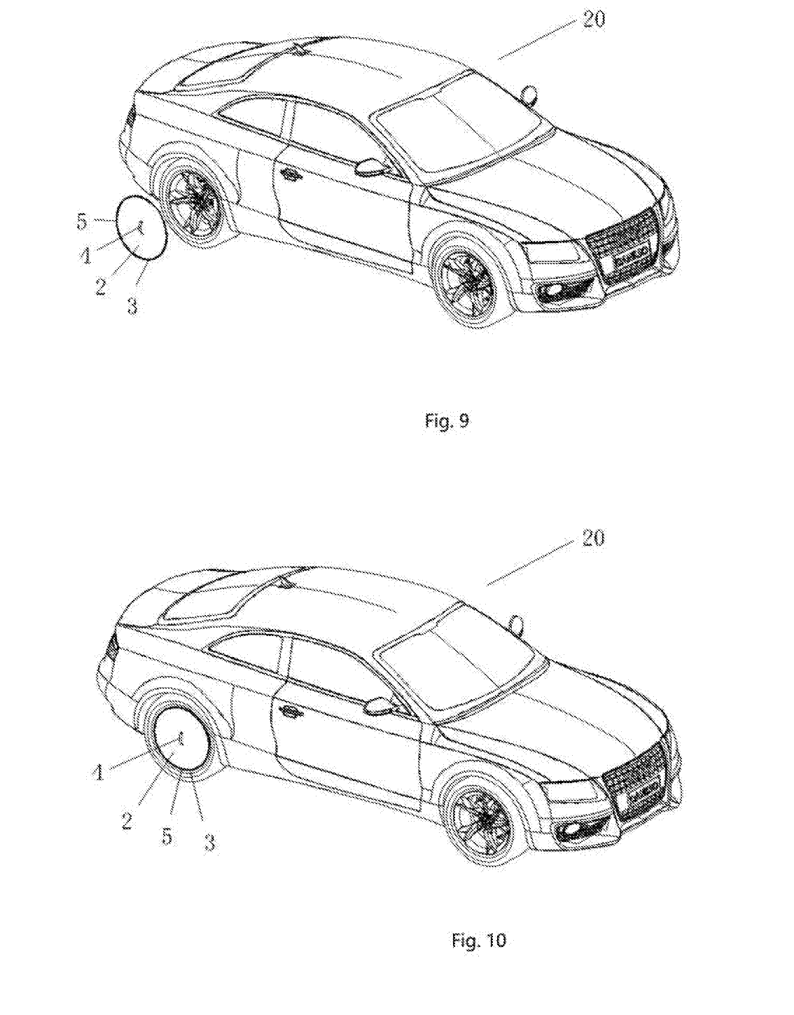

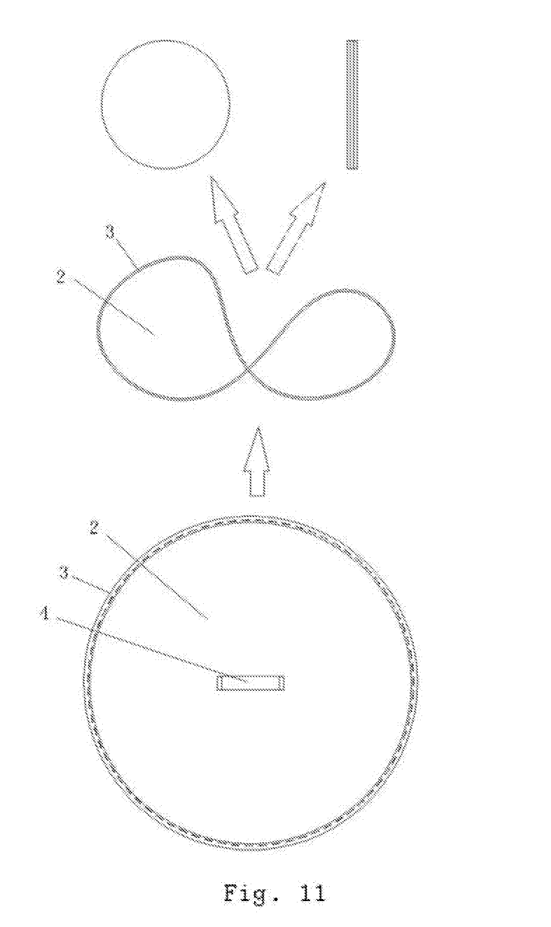

The present invention will be further described below in conjunction with the accompanying drawings and particular embodiments, and in FIGS. 1-11:

An automobile hub protective cover comprises a support ring 1 and a shielding body 2. The support ring 1 is made of a metal wire or strip of high-carbon steel, stainless steel, copper etc., and has the elasticity of enabling the protective cover to be twisted and folded. The outer diameter of the folded protective cover is about one third of the original size, which greatly reduces the packaging size and is convenient to carry. The shielding body 2 is made of cloth such as Oxford and woven cloth or soft plastic sheet such as PVC and PE, or leather such as PVC, PU and cowhide.

The support ring 1 is wrapped by the shielding body 2 after being folded, and the support ring 1 and the shielding body 2 are integrally connected by means of a sewing thread 7 or welding;

or a connecting body 3 is provided, the connecting body 3 being made of cloth such as non-woven fabric and polyester taffeta, or leather such as PVC, PU and cowhide, or soft plastic such as PVC and PE, and the connecting body 3 integrally connecting the support ring 1 and the shielding body 2 by means of a sewing thread 7 or welding.

The diameter or thickness of the metal wire or strip used for the support ring 1 is not greater than 5 mm and the width of the strip is not greater than 30 mm.

Two ends of the metal wire or strip used for the support ring 1 are connected to each other by means of welding, riveting or cold pressing, so as to form a circular ring, the diameter of which should be able to completely cover a corresponding automobile hub 11.

When the shielding body 2 uses cloth such as Oxford and woven cloth, a surface of the shielding body 2 is provided with at least a coating layer for preventing permeation of liquid, to form shielding cloth for preventing permeation of liquid such as a detergent, a brightener and water.

A handle 4 is arranged on the shielding body 2.

The handle 4 is made of cloth such as Oxford and woven cloth, or soft plastic sheet such as PVC and PE, or leather such as PVC, PU and cowhide.

The handle 4 is connected to the shielding body 2 by means of a sewing thread or welding.

Two or more inserts 5 are arranged spaced apart on the support ring 1, and as the inserts 5 are additionally provided, there is no need to support the protective cover by hand during operation.

The inserts 5 are detachably connected to the support ring 1 via an opening 52 in a reversely-fastening manner; or the inserts 5 are undetectably fixed to the support ring 1 by means of welding or riveting (FIG. 6).

The insert 5 is provided at a front end with a projection 51 engageable with the hub 11. The inner diameter of the insert is slightly smaller than the outer diameter of the hub. A pressing force is generated after the front end of the insert comes into contact with the hub 11, and a frictional force resulting from the pressing force ensures that the protective cover will not fall off, so that there is no need to support the protective cover by hand during use.

The above embodiments are only preferred embodiments of the present invention and are not intended to limit the scope of protection of the present invention. Therefore, any equivalent changes made according to the structure, shape and principle of the present invention shall be included in the scope of protection of the present invention.

What is claimed is:

1. An automobile hub protective cover, comprising a support ring (1) and a shielding body (2), characterized in that the support ring (1) is made of a metal wire or strip, and the shielding body (2) is made of cloth or soft plastic sheet or leather; and
the support ring (1) is wrapped by the shielding body (2) after being folded, and the support ring (1) and the shielding body (2) are integrally connected by means of a sewing thread or welding,
or a connecting body (3) is provided, the connecting body (3) being made of cloth or leather or soft plastic, and the connecting body (3) integrally connecting the support ring (1) and the shielding body (2) by means of a sewing thread or welding.

2. The automobile hub protective cover according to claim 1, characterized in that the diameter or thickness of the metal wire or strip used for the support ring (1) is not greater than 5 mm and the width of the strip is not greater than 30 mm.

3. The automobile hub protective cover according to claim 1, characterized in that two ends of the metal wire or strip used for the support ring (1) are connected to each other by means of welding, riveting or cold pressing, so as to form a circular ring, the diameter of which should be able to completely cover a corresponding automobile hub.

4. The automobile hub protective cover according to claim 1, characterized in that when the shielding body (2) is made of cloth, a surface of the shielding body (2) is provided with at least a coating layer for preventing permeation of liquid.

5. The automobile hub protective cover according to claim 1, characterized in that a handle (4) is arranged on the shielding body (2).

6. The automobile hub protective cover according to claim 5, characterized in that the handle (4) is made of cloth or soft plastic sheet or leather.

7. The automobile hub protective cover according to claim 5, characterized in that the handle (4) is connected to the shielding body (2) by means of a sewing thread or welding.

8. The automobile hub protective cover according to claim 1, characterized in that two or more inserts (5) are arranged spaced apart on the support ring (1).

9. The automobile hub protective cover according to claim 8, characterized in that the inserts (5) are detachably connected to the support ring (1) in a reversely-fastening manner; or the inserts (5) are undetectably fixed to the support ring (1) by means of welding or riveting.

10. The automobile hub protective cover according to claim 8, characterized in that the insert (5) is provided at a front end with a projection engageable with a hub.
